(19) United States
(12) Patent Application Publication
(10) Pub. No.: US 2003/0164394 A1
(43) Pub. Date: Sep. 4, 2003

(54) Installation device

(76) Inventors: Tadatomo Suga, Tokyo (JP); Akiro Yamaguchi, Shiga (JP)

Correspondence Address: SMITH PATENT OFFICE, 1901 PENNSYLVANIA AVENUE N W, SUITE 200, WASHINGTON, DC, 20006

(21) Appl. No.: 10/344,939

(22) PCT Filed: Aug. 6, 2001
(86) PCT No.: PCT/JP01/06735

(30) Foreign Application Priority Data
Aug. 18, 2000 (JP) 2000-248654

(51) Int. Cl. B23K 37/00

(52) U.S. Cl. 228/1.1; 228/110.1

(57) ABSTRACT

A mounting apparatus for bonding objects to each other, comprising a cleaning part (3) for cleaning at least the bonding surfaces of first objects (2a, 2b) and a bonding part (4) for bonding the cleaned first objects (2a, 2b) to a second object (2c), wherein both parts are connected to each other so that the objects can be conveyed between both parts, and an inverting mechanism (17) for turning over the first objects (2a, 2b) without touching the cleaned bonding surfaces is provided in the bonding part, whereby the cleaning of the bonding surfaces can be carried out efficiently, and a total time for a series of operations ranging from the cleaning to the completion of bonding can be shortened remarkably.

### TECHNICAL FIELD OF THE INVENTION

The present invention relates to a mounting apparatus for bonding objects such as chips to each other, and specifically to a mounting apparatus having a process for cleaning bonding surfaces.

### BACKGROUND ART OF THE INVENTION

For example, for mounting a chip onto a substrate, a mounting method is known wherein the bonding surface of the chip, as the case may be, the bonding surface of the substrate, is cleaned in various manners, and thereafter, the chip with the cleaned bonding. surface is bonded to the substrate. Usually, a substrate is fixed at a predetermined position on a substrate stage, and a single or a plurality of chips adjusted in positional relationship relative to the substrate are mounted on the substrate.

Although there is a method for cleaning a bonding surface at the substantially same place as a place for bonding, in such a case, because the bonding must be carried out after the cleaning and both operations must be carried out in series, it is difficult to shorten the total time for a series of operations. Therefore, in a manufacturing process where chips and substrates are conveyed continuously and a mass production is required, it becomes difficult to shorten the tact time.

Further, although it is possible to clean the bonding surface of a chip and the bonding surface of a substrate at a condition before mounting where both objects are held to face each other, because the respective surfaces facing in the directions opposite to each other must be cleaned, the cleaning device becomes complicated. Moreover, similarly to the above-described method, since the cleaning and the bonding must be carried out in series, it is difficult to shorten the total time for a series of operations.

On the other hand, recently, a room-temperature bonding method, due to activation of surfaces of objects to be bonded using an energy wave or energy particle beam, has been paid attention to. For example, in Japanese Patent 2,791,429 discloses a room-temperature bonding method of silicon wafers for sputter etching the bonding surfaces of both silicon wafers by irradiating an inert gas ion beam or an inert gas high-speed atomic beam to the surfaces at a vacuum condition with a room temperature prior to the bonding. In this room-temperature bonding method, oxides or organic substances on the bonding surfaces of silicon wafers are removed by the above-described beam and the surfaces are formed by silicon atoms activated by the beam, and both surfaces are bonded to each other by a strong bonding force between the activated atoms. Therefore, in this method, heating for bonding is not necessary, and it is possible to bond the objects at a room temperature. Further, in a case where the surface irregularity is small (the flatness is high), pressing for bonding also becomes unnecessary.

Further, because oxides or organic substances on the bonding surfaces can be removed by the irradiation of the energy wave or energy particle beam in this method, even if a room-temperature bonding is not aimed, for example, even if solder bonding portions are provided as metal bonding portions and basically a heat bonding is to be carried out, it is considered to be possible to apply this method to the cleaning of the bonding surfaces of the objects to be bonded. In such a cleaning due to the irradiation of energy wave or energy particle beam, because a highly cleaned bonding surface can be obtained, if the bonding is carried out while such a state is maintained, it becomes possible to prevent the oxidation of the bonding surfaces or a reaction and adhesion of contamination, which may obstruct the bonding, until performance of the actual bonding, and an extremely reliable bonding state can be realized.

However, in such a room-temperature bonding, or even in a case where the cleaning by means of the irradiation of the energy wave or energy particle beam is carried out, when the irradiation of the energy wave or energy particle beam and the bonding are carried out at a substantially same place, similarly to in the aforementioned case, it becomes difficult to shorten the total time for a series of operations, and it becomes difficult to shorten the tact time in a mass production. Further, since the bonding surface cleaned by the irradiation of the energy wave or energy particle beam becomes a highly cleaned bonding surface, in order to maintain the cleaned state until a time immediately before bonding, the handling of the object after cleaning becomes difficult, and a particular device is required.

### DISCLOSURE OF THE INVENTION

Accordingly, a purpose of the present invention is to provide a mounting apparatus which can clean a bonding surface efficiently, and which can shorten the total time for a series of operations ranging from cleaning to the completion of bonding remarkably and is suitable for a mass production.

Further, paying attention to the advantages of the known excellent room-temperature bonding method and the excellent cleaning effect of the method by the irradiation of energy wave or energy particle beam, another purpose of the present invention is to provide a mounting apparatus which can adequately treat a highly cleaned bonding surface and can bond objects to each other without damaging the excellent cleaning effect even for an apparatus having such an irradiation process of energy wave or energy particle beam, and which can shorten the total time for a series of operations ranging from cleaning to the completion of bonding remarkably and is suitable for a mass production.

To achieve the above-described purposes, a mounting apparatus according to the present invention for bonding a first object onto a second object comprises a cleaning part for cleaning at least a bonding surface of the first object, and a bonding part for bonding the cleaned first object to the second object. In the mounting apparatus, both parts are connected to each other so that the objects can be conveyed between both parts, and an inverting mechanism for turning over the first object without touching the cleaned bonding surface is provided in the bonding part. Although the kinds of the first and second objects are not particularly restricted, for example, the first object is a chip and the second object is a substrate mounted with the chip.

In this mounting apparatus, a conveying means for conveying the first object and the second object while holding them on a tray may be provided between the cleaning part and the bonding part. It is possible to provide a plurality of trays depending on the kinds of the first object and the second object. By providing such a tray, even in a case where there are a plurality of the first objects and the second objects, because they can be conveyed simultaneously, the conveying mechanism can be simplified and the conveying time can be shortened. As the conveying mechanism, for example, a robot hand can be used.

As the above-described inverting mechanism, for example, a mechanism having an attachment, which is attached to the tip portion of the inverting mechanism and hold the first object, can be employed. In this case, it is preferred that the attachment is provided exchangeably depending on the kind of the first object and it is preferred that the attachment is automatically exchanged depending on the kind of the first object. Also for the second object side, an attachment exchangeable depending on the kind of the second object and holding the second object can be provided, and it is preferred that this attachment is also automatically exchanged depending on the kind of the second object. Further, even in a case where the first object or the second object is a single kind, an attachment for exclusive use therefor may be provided, and the attachment may be automatically exchanged.

In order to perform a high-accuracy bonding, it is preferred that a recognition means for reading recognition marks for positioning of first object side and second object side is provided in the above-described bonding part. This recognition means comprises, for example, a two-sight recognition means, and it is disposed so as to be able to be proceeded to and retreated from a position between the first object and the second object. Alternatively, a recognition means for reading recognition marks of first object side and a recognition means for reading recognition marks of second object side may be provided separatedly. The parallelism between the first object and the second object can be determined from the read information of the respective recognition marks by the recognition means, and in accordance with the determination, for example, by adjustment in the directions of three axes X, Y and Z and in the rotational direction θ around Z axis, a high-accuracy positioning becomes possible. If a positioning mechanism having a coarse adjusting mechanism and a fine adjusting mechanism using, for example, piezoelectric elements, is employed, a further high-accuracy positioning becomes possible.

A structure having a special gas replacing means can be employed for the abovedescribed cleaning part, and the cleaning can be carried out in a special gas atmosphere. The special gas in the present invention means, for example, an inert gas such as argon gas, a gas such as nitrogen gas which does not react with the objects, a gas which can replace the surface oxides to fluoro groups and the like on the surfaces of the objects, a gas which contains hydrogen and can react at a reducing condition on the surfaces of the objects, or a gas which contains oxygen and can remove carbons (organic substances) on the surfaces of the objects. By cleaning in such a special gas atmosphere or in a plasma using such a special gas, the oxides and organic substances on the bonding surfaces of the first object and the second object can be removed efficiently, and the bonding may be facilitated. In this case, in order to maintain the cleaned bonding surface at a clean condition until the time immediately before bonding, a special gas replacing means for replacing the atmosphere to a special gas atmosphere similar to the above-described atmosphere may be provided also for the bonding part, and the bonding may be carried out in the special gas atmosphere. Further, a pressure reducing means may be provided for the cleaning part or/and the bonding part, and by treatment in a gas atmosphere with a predetermined vacuum degree, it is possible to further increase the cleaning effect and the effect for preventing the oxidation until the bonding.

Although it is possible to form the cleaning part and the bonding part, respectively, in a single chamber, it is preferred that the cleaning part and the bonding part are installed in respective chambers different from each other, in order to carry out the respective operations of cleaning and bonding completely independently. In this case, for example, if a shutter means capable of being opened and closed is provided between the chamber installing the cleaning part and the chamber installing the bonding part, the inside of each chamber can be formed as a desired atmosphere quickly and easily.

Further, in the mounting apparatus according to the present invention, the cleaning part may be constructed to have means for irradiating an energy wave or energy particle beam to a surface of an object in order to clean the surface. As the energy wave or energy particle beam, for example, a plasma (including an atmospheric-pressure plasma), an ion beam, an atomic beam, a radical beam or a laser can be used. The application of the aforementioned room-temperature bonding becomes possible by providing such an irradiation means of the energy wave or energy particle beam. Of course, regardless of a condition where the irradiation means of the energy wave or energy particle beam is present or not, the mounting apparatus according to the present invention can be constructed as an apparatus in which basically a heat bonding is carried out. For example, a constitution can be employed wherein the first object has a metal bonding portion, and the bonding part of the mounting apparatus has means for thermally bonding the metal bonding portion to a portion to be bonded of the second object. The metal bonding portion in the present invention means a generic term of a bonding portion due to a metal including a bonding portion due to a usual solder of lead/tin, and other bonding portions due to a so-called substitute solder such as tin/silver or Bi/In and bonding portions due to gold/tin or gold/gold.

In the mounting apparatus according to the present invention thus constructed, because the cleaning part and the bonding part are separatedly constructed, in the cleaning part, a disposition most efficient for cleaning can be employed regardless of the disposition of the first object and the second object in the bonding part. For example, when the first object and the second object are cleaned together, the bonding surface of the first object and the bonding surface of the second object to be cleaned are directed in the same direction, and it is possible to clean both surfaces from the direction by the cleaning means efficiently in a short time.

Further, since the cleaned first and second objects can be conveyed together to the bonding part as a set (in a case where a plurality of both objects are present, they are formed as one set), the conveying is easy and it can be carried out in a short time. Although it is necessary to face the bonding surface of the first object and the bonding surface of the second object to each other in the bonding part, the first object is turned over by the inverting mechanism easily and quickly, and both bonding surfaces are faced to each other. At that time, because the inverting mechanism, particularly, the attachment for holding the first object, does not touch the cleaned bonding surface of the first object, a desirable good bonding carried out without damaging the cleaning effect for the bonding surface and without giving any bad influence to the bonding to be carried out thereafter.

Thus, the cleaning is carried out efficiently, and while the well cleaned bonding surface is maintained at a clean condition, a series of operations from cleaning to bonding are carried out smoothly and quickly.

Further, by providing the cleaning part and the bonding part separatedly from each other, in particular, by forming the cleaning part and the bonding part in the chambers different from each other, it becomes possible to perform the cleaning operation and the bonding operation completely independently, and during the bonding operation, the cleaning of a next object can be carried out at the same time. As a result, in a manufacturing process of a mass production where objects are sent continuously, the tact time ofthis cleaning/bonding process can be remarkably shortened. Furthermore, the atmospheres of the cleaning part and the bonding part can be set as respective optimum atmospheres, and the respective operations for cleaning and bonding can be carried out at respective optimum conditions.

As the flow of the cleaning/bonding process and the following process, a substantially one-way flow such as a flow of from the cleaning process to the bonding process and from the bonding process to the following process may be employed, and another flow may also be employed, for example, wherein the objects are conveyed from the cleaning process to the bonding process, from the bonding process to the following process once through an appropriate place in the cleaning process or a place near the cleaning process.

As the following process, a process for finally bonding the first and second objects can be raised. Namely, in the mounting apparatus according to the present invention, the abovedescribed bonding part having an inverting mechanism may be constructed as a temporary bonding part, and a final bonding part for finally bonding both objects may be connected to the temporary bonding part so that both objects temporarily bonded can be conveyed between both parts. In the final bonding part, at least one of a heating means, a pressing means and an ultrasonic bonding means can be provided. Namely, in the final bonding process, the final bonding can be carried out by one of heating, pressing and vibration due to an ultrasonic wave, or by an appropriate combination thereof Thus, by performing such a final bonding due to one of heating, pressing and vibration due to an ultrasonic wave or due to an appropriate combination thereof, a fine gap and a residual stress on the interface between both objects can be removed and the throughput is improved.

Thus, in the mounting apparatus according to the present invention, particularly the cleaning of the bonding surfaces can be carried out efficiently and the bonding can be started without damaging the state of the cleaned bonding surfaces, and an extremely reliable bonding state can be obtained. Further, a series of operations ranging from the cleaning to the completion of the bonding can be carried out efficiently and smoothly, the total time for the series of operations can be shortened, and the tact time can be shortened remarkably. Furthermore, the present invention can be applied to a case performing a room-temperature bonding.

### BRIEF EXPLANATION OF THE DRAWINGS

FIG. 1 is a schematic vertical sectional view of a mounting apparatus according to an embodiment of the present invention.

FIG. 2 is an enlarged perspective view of a tray holding objects in the apparatus shown in FIG. 1.

FIG. 3 is an enlarged partial elevational view of the apparatus shown in FIG. 1.

FIG. 4 is an enlarged sectional view of an attachment holding a first object in the apparatus shown in FIG. 1.

FIG. 5 is a sectional view showing a modification of an attachment.

FIG. 6 is a sectional view showing another modification of an attachment.

FIG. 7 is a schematic view of a mounting apparatus according to another embodiment of the present invention.

### THE BEST MODE FOR CARRYING OUT THE INVENTION

Hereinafter, desirable embodiments of the present invention will be explained referring to figures.

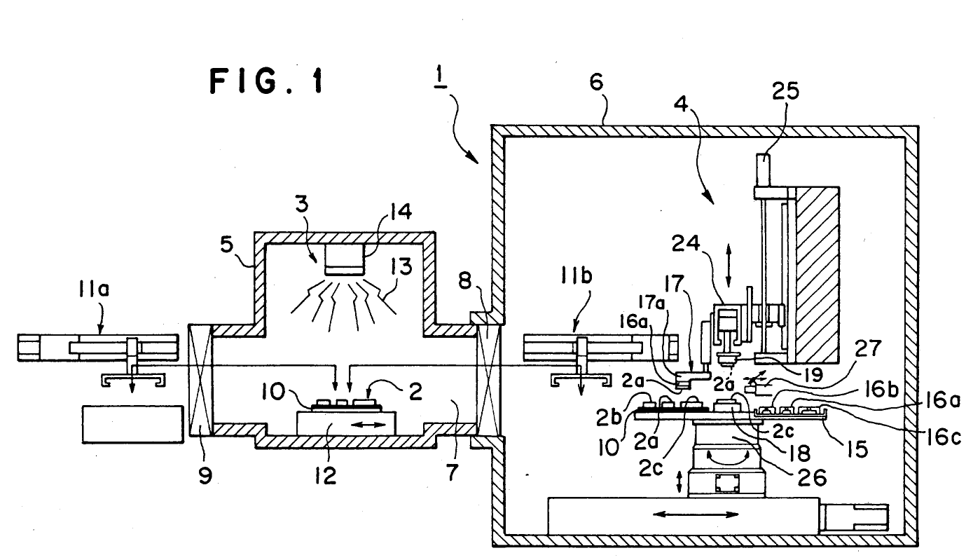

FIG. 1 shows a mounting apparatus according to an embodiment of the present invention. A mounting apparatus 1 comprises a cleaning part 3 for objects to be bonded 2, and a bonding part 4 for bonding objects 2 to each other, and in this embodiment, the cleaning part 3 is installed in a cleaning chamber 5 and the bonding part 4 is installed in a bonding chamber 6. Both chambers 5 and 6 are connected to each other via a conveying path 7 so that objects 2 can be conveyed between both chambers, a shutter means 8 capable of being opened and closed is provided between both chambers 5 and 6, and a shutter means 9 is provided also at the entrance side of the cleaning chamber 5.

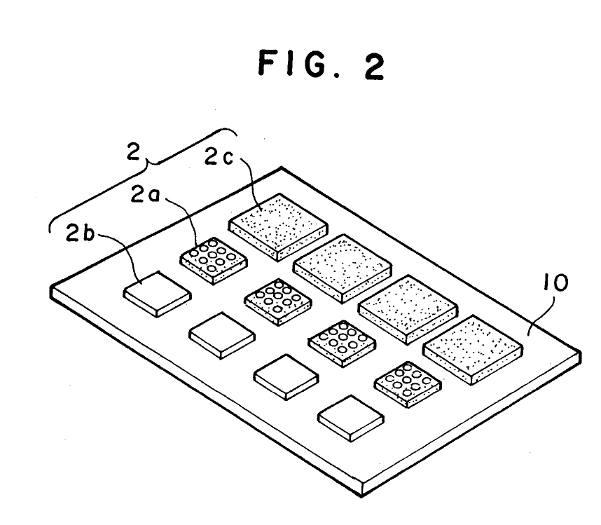

As the objects 2, in this embodiment, for example, as shown in FIG. 2, chips 2a and chips 2b are prepared as first objects and substrates 2c are prepared as second objects, a first object (a chip) 2a is bonded onto the substrate 2c at a condition turned over from the state shown in FIG. 2, and thereonto, another first object (a chip) 2b is bonded at a condition turned over from the state shown in FIG. 2. FIG. 2 shows a plurality of sets of first objects 2a and 2b and second objects 2c to be thus bonded, and shows a state where the plurality of objects 2 are held on a tray 10. As shown in FIG. 1, tray 10 holding the plurality of sets of these objects 2 is introduced into cleaning part 3 by a conveying robot 1 la provided as conveying means, and after cleaning, it is conveyed to bonding part 4 by a conveying robot 1b provided as conveying means.

The tray 10 introduced into cleaning part 3 and holding objects 2 is held at a predetermined position on a cleaning stage 12. An energy wave irradiating means 14 (or an energy particle beam irradiating means) for irradiating an energy wave or energy particle beam 13 is provided in cleaning part 3 for cleaning the bonding surfaces of objects 2. As the energy wave or energy particle beam, as aforementioned, any one of a plasma, an ion beam, an atomic beam, a radical beam and a laser can be used. In this embodiment, although the bonding surfaces of first objects 2a and 2b and second object 2c held on tray 10 are cleaned together by irradiation of energy wave or energy particle beam 13, for example, in a case where the bonding surface of second object 2c is not required, only the surfaces of at least first objects 2a and 2b may be cleaned. Further, in a case where energy wave or energy particle beam 13 is irradiated in a slit-like or spot-like form, it is preferred that cleaning stage 12 can be adjusted in position in the arrow direction or can be translated in parallel in the horizontal direction.

A special gas replacing means (not shown) for replacing the atmosphere in cleaning part 3 to a special gas atmosphere such as an aforementioned atmosphere may be provided to cleaning chamber 5. It becomes possible to increase the cleaning effect by cleaning due to the irradiation of energy wave or energy particle beam under a condition of the special gas atmosphere. Further, together with the special gas replacing means, or without providing the special gas replacing means, a pressure reducing means such as a vacuum pump may be provided. It also becomes possible to increase the cleaning effect by cleaning due to the irradiation of energy wave or energy particle beam under a condition of a reduced pressure.

A special gas replacing means (not shown) for replacing the atmosphere in bonding part 4 to a special gas atmosphere may be provided also to bonding chamber 6. In such a special gas atmosphere, the above-described excellent cleaning effect of the bonding surface can be maintained up to a time immediately before bonding, and a better bonding state can be obtained. Further, also for this bonding chamber 6, a pressure reducing means such as a vacuum pump may be provided, together with the special gas replacing means, or without providing the special gas replacing means. It becomes possible to obtain a further better bonding state by bonding under a condition of a reduced pressure.

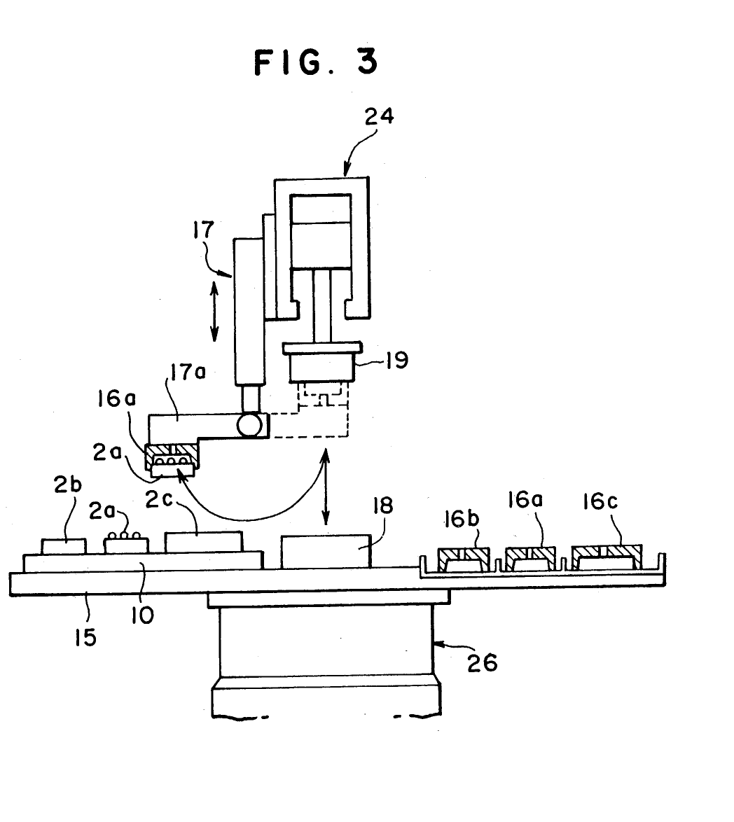

A table 15 is provided in bonding part 4, and tray 10 holding first objects 2a and 2b and second object 2c, which has been conveyed by conveying robot 12, is placed at a predetermined position on the table, also as shown in FIG. 3. Further, attachments in accordance with the kinds of the respective objects, in this embodiment, attachments 16a and 16b for holding first objects 2a and 2b and attachment 16c for holding second object 2c, are provided exchangeably depending on the kinds of the objects to be held, at a position opposite to the position for placing tray 10 on table 15. These attachments 16a to 16c can hold the respective objects 2a to 2c without touching the cleaned bonding surfaces of the respective objects 2a to 2c, respectively.

First objects 2a and 2b are turned over for the bonding, and second object 2c is not turned over. The respective attachments 1 6a to 1 6c are attached to the tip portion (the lower end) of inverting mechanism 17 depending on the kinds of the objects to be held, and for first objects 2a and 2b, after they are held by attachments 16a and 16b, an arm 17a of inverting mechanism 17 is turned over, and for second object 2c, without inverting the arm 17a, the second object 2c held by attachment 16c is transferred to and held at a predetermined position on stage 18.

For example, as shown FIGS. 1 and 3, first object 2a is held on attachment 16a so that its cleaned bonding surface is not touched, and at such a condition, arm 17a is turned over, the inverted first object 2a is held on the lower surface of tool 19, for example, by suction. Inverting mechanism 17 can be moved vertically as shown by the arrow in FIG. 3, and after the above-described inverting operation and suction operation, it can be retreated so as not to obstruct the following bonding operation.

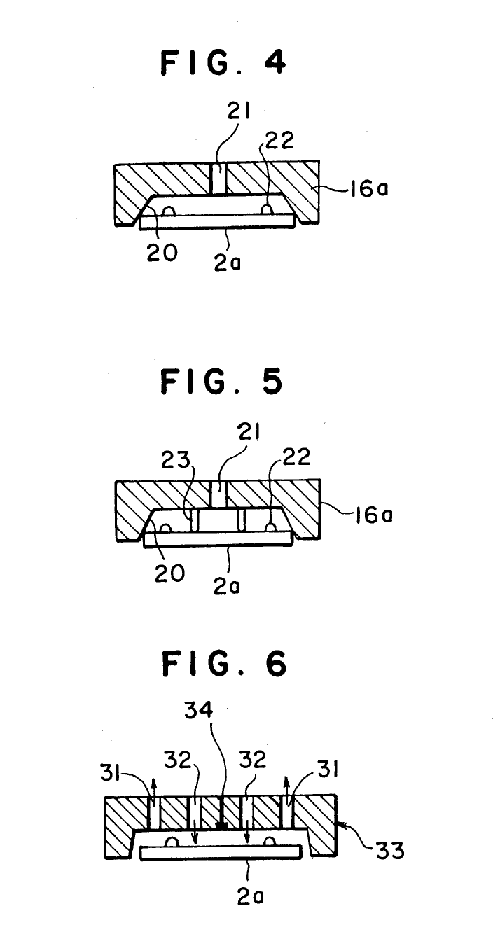

As the structure for holding first object 2a by attachment 16a without touching the cleaned bonding surface, for example, as shown in FIG. 4, the attachment 16a is formed in a shape having a tapered opening 20, and the first object 2a can be held without touching the cleaned bonding surface by holding the first object 2a at the tapered surfaces and by holding it by suction through a suction hole 21. In first object 2a (a chip) shown in FIG. 4, portions of bumps 22 form the bonding surface. For example, bumps 22 are made of solder bumps as metal bonding portions capable of being thermally bonded.

Further, as shown in FIG. 5, an appropriate number of pins 23 may be stood up in opening 20 of attachment 16a . Pins 23 come into contact with a portion of first object 16a except the bonding surface (a portion except bumps 22). Particularly in a case where the rigidity of first object 2a is not so high, a deflection of the first object 2a can be prevented by thus supporting the intermediate portions of the object.

Further, as shown in FIG. 6, a structure may be employed wherein an attachment 33 having gas suction holes 31 and gas blowing holes 32 is used, a force operating on object 2a is balanced by the suction and blowing of gas so that a gap relative to the object 2a is maintained to be constant based on the feedback information from a gap sensor 34, and the object 2a is sucked and held at a substantially non-contact condition. The feedback may be carried out, for example, by measuring a suction force for sucking the object, except based on the information from the gap sensor.

Tool 19 is constructed as a tool incorporating a heater for a case where a heat bonding is carried out, and as a tool which does not have a heater for a case where a room-temperature bonding is carried out. In this embodiment, tool 19 is attached to the lower end of a pressing cylinder 24 movable vertically. Pressing cylinder 24 can be moved vertically or controlled in vertical movement and rotational movement by a vertical movement device 25, and after the vertical positioning is completed, tool 19 is moved down, thereby carrying out the pressing.

Stage 18 is disposed on a position adjusting table 26 capable of being controlled in movement in parallel and positioning in a rotational direction, and via the positioning of this position adjusting table 26, the relative positioning between second object 2c held on stage 18 and first object 2a (2b ) held on tool 19 and the adjustment of the parallelism therebetween can be carried out. Although these positioning and adjustment in parallelism are carried out on the stage 18 side (second object 2c side) in this embodiment, these may be carried out on the tool 19 side (first object 2a side) or on both sides.

In this embodiment, between first object 2a held on tool 19 and second object 2c held on stage 18, a recognition means 27 for reading the recognition marks for positioning therebetween is provided so as to be proceeded to and retreated from a position therebetween. This recognition means 27 comprises, for example, a two-sight camera, and it can read both the recognition mark provided on first object 2a (2b ) or the lower surface of tool 19 and the recognition mark provided on second object 2c or the upper surface of stage 18. Base on the read information, position adjusting table 26 is controlled, and the positioning and parallelism adjustment are carried out. For the reading, recognition means 27 can be controlled in parallel movement in the horizontal directions X and Y and/or in positioning in the vertical direction Z. As aforementioned, this recognition means may be constructed as means for separatedly reading first object 2a held on tool 19 and second object 2c held on stage 18, respectively.

In the mounting apparatus 1 constructed as described above, because cleaning part 3 and bonding part 4 are formed as different parts, as shown in FIG. 1, first objects 2a and 2b and second object 2c can be cleaned together at a condition directing their bonding surfaces upward, and the efficiency for cleaning can be increased and the time therefor can be shortened.

Since the cleaned first objects 2a and 2b and second object 2c are conveyed to bonding part 4 at a condition held on tray 10, the efficiency for conveying is good and the time therefor is short.

First objects 2a and 2b, which should be turned over for bonding among the objects conveyed into bonding chamber 6, are turned over by inverting mechanism 17, and held on tool 19. At that time, since first objects 2a and 2b are held via attachments 16a and 16b without touching the cleaned bonding surfaces and turned over and sucked and held by tool 19 at that condition, the cleaned bonding surfaces can be kept at a clean condition during the time up to an actual bonding. Because it is bonded to second object 2c at this condition, the bonding is carried out at an optimum condition for the bonding surfaces, and a desirable high-reliability bonding state can be obtained. Even in a case aiming a room-temperature bonding, by maintaining the bonding surfaces of first and second objects at a good condition required for the room-temperature bonding, a desirable good bonding state can be obtained.

Thus, a series of operations ranging from the cleaning to the completion of bonding are carried out smoothly and continuously at the respective desirable conditions. Further, because the cleaning and the bonding can be carried out independently, as needed, the bonding and the next cleaning can be proceeded simultaneously. By such efficient cleaning, desirable bonding and efficient and smooth flow of a series of operations, especially the tact time for a mass production can be shortened remarkably.

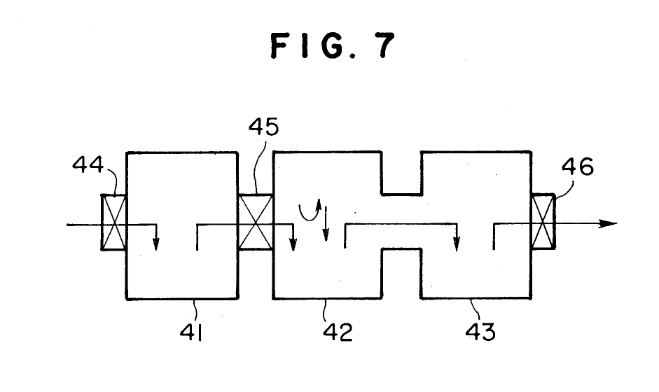

In the present invention, it is also possible to employ a constitution wherein the bonding part having the above-described inverting mechanism is constructed as a temporary bonding part for temporarily bonding first and second objects, and to this temporary bonding part, a final bonding part for finally bonding both objects is connected so that the temporarily bonded both objects can be conveyed to the final bonding part. For example, as shown in FIG. 7 as a schematic structure, a cleaning part 41 having a structure similar to that of the aforementioned one, a temporary bonding part 42 having an inverting mechanism and a final bonding part 43 which does not have an inverting mechanism are connected to each other in this order, and shutter means 44, 45 and 46 are provided at the entrance portion of the cleaning part 41, between the cleaning part 41 and the temporary bonding part 42, and at the exit portion of the final bonding part 43, respectively. It is preferred that at least one means of a heating means, a pressing means and an ultrasonic bonding means (not shown) is provided in final bonding part 43, as aforementioned, and the final bonding can be carried out by one of heating, pressing and vibration due to an ultrasonic wave, or by an appropriate combination thereof Thus, by performing such a final bonding due to one of heating, pressing and vibration due to an ultrasonic wave or due to an appropriate combination thereof in final bonding part 43, a fine gap and a residual stress on the interface at the bonding region between first and second objects can be removed and a further desirable bonding state can be obtained.

### Industrial Applications of the Invention

The mounting apparatus according to the present invention can be applied to any type of mounting apparatuses for bonding objects to each other after at least the bonding surface of one object is cleaned, and an efficient cleaning, a desirable bonding, and a remarkable shortening of the tact time of a series of processes can be achieved. Further, the mounting apparatus according to the present invention can also be appropriately applied to an apparatus having a cleaning process by means of the irradiation of an energy wave or energy particle beam.

1. A mounting apparatus for bonding a first object onto a second object comprising:
a cleaning part for cleaning at least a bonding surface of said first object; and
a bonding part for bonding said cleaned first object to said second object, wherein both parts are connected to each other so that the objects can be conveyed between both parts, and an inverting mechanism for turning over said first object without touching said cleaned bonding surface is provided in said bonding part.

2. The mounting apparatus according to claim 1, wherein a conveying means for conveying said first object and said second object while holding them on a tray is provided between said cleaning part and said bonding part.

3. The mounting apparatus according to claim 1, wherein said inverting mechanism has an attachment for holding said first object, and said attachment is provided exchangeably depending on the kind of said first object.

4. The mounting apparatus according to claim 1, wherein an attachment for holding said second object is provided in said bonding part, and said attachment is provided exchangeably depending on the kind of said second object.

5. The mounting apparatus according to claim 1, wherein a recognition means for reading recognition marks for positioning of first object side and second object side is provided in said bonding part.

6. The mounting apparatus according to claim 1, wherein a special gas replacing means is provided for said cleaning part.

7. The mounting apparatus according to claim 1, wherein a special gas replacing means is provided for said bonding part.

8. The mounting apparatus according to claim 1, wherein a pressure reducing means is provided for said cleaning part.

9. The mounting apparatus according to claim 1, wherein a pressure reducing means is provided for said bonding part.

10. The mounting apparatus according to claim 1, wherein said cleaning part and said bonding part are installed in respective chambers different from each other.

11. The mounting apparatus according to claim 10 wherein a shutter means capable of being opened and closed is provided between said chamber installing said cleaning part and said chamber installing said bonding part.

12. The mounting apparatus according to claim 1, wherein said cleaning part has means for irradiating an energy wave or energy particle beam to a surface of an object in order to clean the surface.

13. The mounting apparatus according to claim 11, wherein a plasma, an ion beam, an atomic beam, a radical beam or a laser is used as said energy wave or energy particle beam.

14. The mounting apparatus according to claim 1, wherein said first object has a metal bonding portion, and said bonding part has means for thermally bonding said metal bonding portion to a portion to be bonded of said second object.

15. The mounting apparatus according to claim 1, wherein said bonding part is constructed as a temporary bonding part for temporarily bonding said first object and said second object to each other, and a final bonding part for finally bonding both objects is connected to said temporary bonding part so that both objects temporarily bonded can be conveyed between both parts.

16. The mounting apparatus according to claim 15, wherein said final bonding part has at least one of a heating means, a pressing means and an ultrasonic bonding means.
